(19) United States
(12) Patent Application Publication
(10) Pub. No.: US 2007/0094159 A1
(43) Pub. Date: Apr. 26, 2007

(54) Information processing apparatus, information processing system, and information processing program

(75) Inventor: Hideya Takeo, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/529,438

(22) Filed: Sep. 29, 2006

(30) Foreign Application Priority Data
Sep. 29, 2005 (JP) 283833/2005

(51) Int. Cl. G06F 15/18

(52) U.S. Cl. 706/12; 706/44

(57) ABSTRACT

Misunderstanding in use of an application program for CAD or the like is lessened. When the application program is executed, functions provided by the application program are restricted. Training means for carrying out training on how to use the functions is provided, and completion of the training by the training means is confirmed regarding a user. Thereafter, training completion information representing the completion of the training is stored. Based on the training completion information, the restriction on provision of the functions of the application program is lifted.

### BACKGROUND OF THE INVENTION

1. Field of the Invention

The present invention relates to an information processing apparatus that executes an application program providing a predetermined function, and to a program therefor.

2. Description of the Related Art

In the field of medicine, so-called CAD processing that analyzes digital medical images by use of computers is carried out to reduce the burden of interpreting images for diagnosis on doctors and the like. Methods for automatic detection of lesions appearing in medical images are also known.

The abbreviation “CAD” means either Computer Aided Detection or Computer Aided Diagnosis. The former refers to finding lesions overlooked by doctors while the latter refers to assisting doctors in making diagnoses by provision of information useful to the diagnoses.

However, a considerable number of people seem to have the wrong understanding or expectations on CAD (see R. Hasegawa, “Practical Use of CAD Systems and Know-how for the Spread thereof”, INNERVISION, Vol. 19, No. 12, pp. 21-24, 2004, for example) . For example, some people say that CAD provides a second opinion. However, CAD simply indicates anomalies that doctors interpreting images should pay attention to at least once, and is far from a second opinion. Others say that CAD that achieves a low successful detection rate is not useful. However, CAD leads to less oversight of cancers by alerting doctors to cancers overlooked by the doctors but detected by CAD.

Therefore, in order to lessen such misunderstandings, manufacturers of CAD systems provide training on CAD by trainers targeting doctors and medical technicians at the time of installation thereof. In the training, operation manuals are explained, and various cases are confirmed with results of CAD for better understanding by use of images actually displayed on image display systems (see Fuji Photo Film Co., Ltd., “FUJIFILM MAMMOGRAPHY CAD (Computer Aided Detection) SYSTEM Clinical Case Database Manual for MV-SR657 Version 3.0)” and Fuji Photo Film Co., Ltd., “FUJIFILM MAMMOGRAPHY CAD (Computer Aided Detection) SYSTEM detection processing manual for MV-SR657 Version 3.0)”, for example).

However, even in the case where training has been provided at the time of installation of systems, the training may not necessarily have been provided to doctors and medical technicians that use the systems. Furthermore, even doctors and medical technicians having received the training do not necessarily have sufficient understanding. Therefore, it is difficult to remove misunderstanding by doctors and medical technicians not having received such training.

### SUMMARY OF THE INVENTION

In order to lessen misunderstanding upon use of an application program for CAD or the like, the present invention provides an information processing apparatus, an information processing system, and an information processing program that provide a training method for users of the application program.

An information processing apparatus of the present invention comprises:

program storage means for storing an application program that provides predetermined functions;

execution means for executing the application program;

restriction means for imposing a restriction on the functions provided by the application program when the application program is executed by the execution means;

training completion information input means for carrying out input of training completion information representing completion of training by a training function on how to use the functions provided by the application program; and

restriction lifting means for lifting the restriction imposed by the restriction means on provision of the functions of the application program, based on the input of the training completion information.

A program of the present invention causes a computer to function as:

restriction means for imposing a restriction on predetermined functions provided by an application program when the application program that provides the functions is executed by execution means of the computer;

training completion information input means for carrying out input of training completion information representing completion of training on how to use the functions provided by the application program; and

restriction lifting means for lifting the restriction imposed by the restriction means on provision of the functions of the application program, based on the input of the training completion information.

Another information processing apparatus of the present invention comprises:

program storage means for storing an application program that provides predetermined functions;

execution means for executing the application program;

restriction means for imposing a restriction on the functions provided by the application program when the application program is executed by the execution means;

training means for providing a training function that carries out training on how to use the functions of the application program;

training completion confirmation means for confirming completion of the training by the training means;

training completion information storage means for storing training completion information representing the completion of the training after the training completion confirmation means has confirmed the completion of the training; and

restriction lifting means for lifting the restriction imposed by the restriction means on provision of the functions of the application program, based on the training completion information.

The execution means refers to an execution environment as an infrastructure for providing functions necessary for execution of the application program. More specifically, the execution means refers to an operating system, software having functions such as disc management and file restoration necessary for the execution of the application program, and hardware such as a CPU and a memory that executes the functions.

The application program is a computer program having specific functions that support tasks performed by people. Unlike an operating system, the application program carries out processing by using characters, figures, images and a combination thereof. More specifically, the application program can be a CAD program.

The restriction on the functions provided by the application program refers to cause all or a part of the functions of the application program to become unusable.

Lifting the restriction imposed by the restriction means on provision of the functions of the application program based on the input of the training completion information refers not only to the case of lifting the restriction so as to cause the functions of the application program to become usable whenever the training completion information is input while the functions of the application program remain unusable if the training completion information is not input but also to the case of lifting the restriction so that the functions can always be used once the training completion information has been input.

As an example of the case where the restriction is lifted whenever the training completion information is input, the training completion information may be stored in a memory recording medium or a magnetic card so that the functions of the application program can be used when the training completion information in the recording medium or the magnetic card is read and input. Alternatively, the training completion information maybe input each time via a network, through connection to the network.

The information processing apparatuses may further comprise login means for letting a user log in thereto and the training completion information may include user information on a user having completed the training. In this case, if the user currently logging on by use of the login means is the same as the user represented by the user information included in the training completion information, the restriction lifting means lifts the restriction.

Login refers to enabling a user to access a computer system or a resource on a network. For example, in the case where a user logs in to a system, login refers to identification of the user and software trying to access a resource by input of a user ID and a password.

The training completion confirmation means may comprise achievement rate judgment means for judging a rate of achievement in the training by the training means so that the completion of the training can be confirmed based on the rate of achievement judged by the achievement rate judgment means.

The predetermined functions may be image processing functions.

An information processing system of the present invention comprises:

a client computer that executes an application program providing predetermined functions and a management server computer that is connected to the client computer by a network and manages users using the application program.

The client computer comprises:

login means for letting a user log on thereto;

user information sending means for sending, to the management server computer, user information representing the user having logged on;

program storage means for storing the application program;

execution means for executing the application program; and

restriction means for imposing a restriction on the functions provided by the application program when the application program is executed by the execution means.

The management server computer comprises:

user information reception means for receiving the user information from the client computer;

training completion information storage means for storing training completion information including user information of a user having completed training on how to use the functions provided by the application program;

completion judgment means for carrying out judgment as to whether the user logging onto the client computer is the user having completed the training, based on the training completion information and the user information received from the client computer; and

completion judgment result sending means for sending a result of the judgment by the completion judgment means to the client computer.

The client computer further comprises:

completion judgment result reception means for receiving the result of the judgment from the management server computer; and

restriction lifting means for lifting the restriction imposed by the restriction means on provision of the functions of the application program in the case where the user logging onto the client computer has been confirmed to have completed the training according to the result of the judgment.

In the information processing system of the present invention, the client computer may further comprise:

training means for providing a training function carrying out training on how to use the functions provided by the application program to the user having logged on,;

training completion confirmation means for confirming that the user has completed the training; and

training completion information sending means for sending training completion information including the user information of the user having completed the training to the management server computer.

In this case, the management server computer may further comprise:

training completion information reception means for receiving the training completion information from the client computer.

According to the present invention, the functions provided by the application program are restricted in the case where the training on how to use the functions provided by the application program has not been completed while the application program becomes usable in the case where the training has been completed. In this manner, the functions of the application program can be used based on accurate understanding thereof. Consequently, misunderstanding regarding the application program can be lessened and the application program can be used effectively.

The functions of the application program usable by a user not having finished the training can be limited by managing whether each login user has completed the training.

By judging the rate of achievement in the training, the functions of the application program can be used depending on whether each of the users sufficiently understands the application program.

Furthermore, by connecting the client computer executing the application program to the management server computer managing the users using the application program via the network and by managing whether each of the users has completed the training by use of the management server computer, each of the users can use the application program not only on the computer placed at one location but also on the computers placed at various locations.

Moreover, by installing the training function in the computer and by storing the information on completion of the training by each of the users in the management server computer, each of the users having completed the training by use of the computer placed at one location can use the application program on the computers other than the computer placed at the one location.

### BRIEF DESCRIPTION OF THE DRAWINGS

FIG. 1 shows the configuration of an information processing apparatus of a first embodiment of the present invention;

FIG. 2 is a flow chart showing operation of the information processing apparatus in the first embodiment;

FIG. 3 shows the configuration of a modification to the information processing apparatus of the first embodiment;

FIG. 4 shows the configuration of an information processing system of a second embodiment of the present invention; and

FIG. 5 is a flow chart showing operation of the information processing system in the second embodiment of the present invention.

### DESCRIPTION OF THE PREFERRED EMBODIMENTS

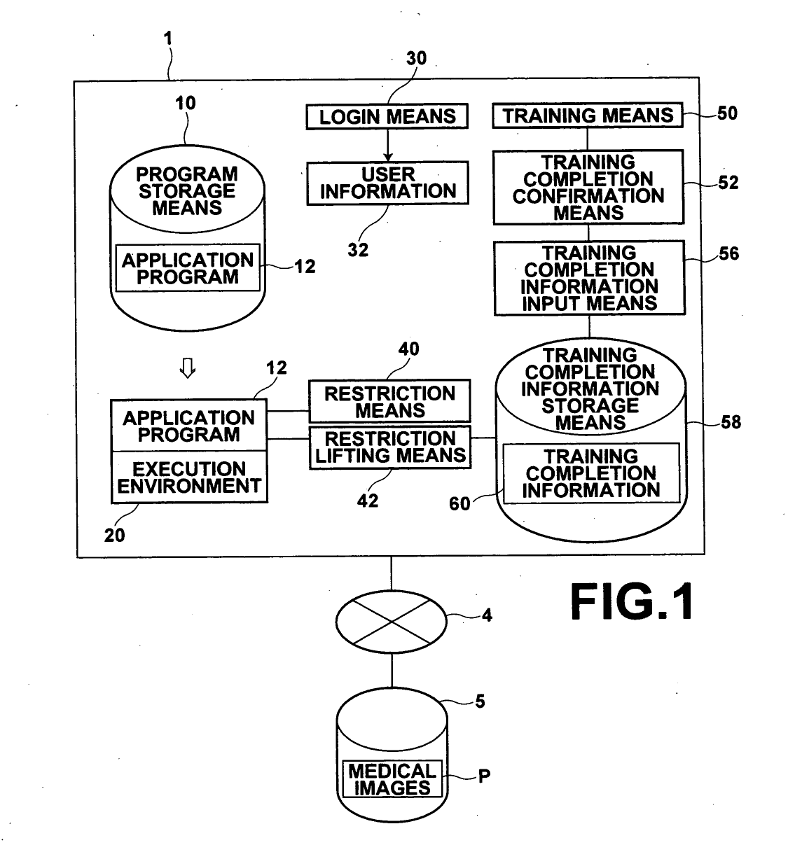

Hereinafter, a first embodiment of the present invention is described with reference to the accompanying drawings. FIG. 1 shows the configuration of an information processing apparatus 1 in the first embodiment.

The information processing apparatus 1 of the present invention comprises program storage means 10 for storing an application program 12 providing predetermined functions, execution means 20 for executing the application program 12, login means 30 for letting a user log in to the information processing apparatus 1, restriction means 40 for imposing a restriction on the functions provided by the application program 12 when the application program 12 is executed, training means 50 for providing a training function carrying out training on how to use the functions provided by the application program 12, training completion confirmation means 52 for confirming completion of the training by the training means 50, training completion information storage means 58 for storing training completion information 60, training completion information input means 56 for inputting the training completion information 60 to the training completion information storage means 58 after completion of the training has been confirmed by the training completion confirmation means 52, and restriction lifting means 42 for lifting the restriction on provision of the functions of the application program 12.

The application program 12 is a program for providing specific functions that support tasks performed by people such as data editing regarding images and characters and data analysis. The application program 12 is generally executed by an execution environment (the execution means 20) such as an operating system.

The application program 12 may automatically generate and analyze image data, as in the case of CAD. Following the recent spread of digital medical images obtained by radiography of human bodies with CR and CT apparatuses, CAD (Computer Aided Detection or Computer Aided Diagnosis) is becoming commoner for detecting abnormal shadows through analysis of digital medical images. However, correct judgment is not necessarily made by use of the detection function of CAD. For example, some suspicious images actually do not represent abnormal shadows although the images do have a characteristic of images having a high probability of being abnormal shadows. In addition, abnormal shadows found by doctors may not be detected by CAD.

Consequently, users of CAD such as doctors interpreting images need to judge whether detected abnormal shadows actually represent anomalies such as cancer or shadows not representing anomalies but having a characteristic of abnormal shadows due to radiography thereof in overlay with another structure, by using CAD with proper understanding of a characteristic thereof. However, some users make diagnoses with misunderstanding of CAD results. For this reason, in the case where this type of application program is used, the program needs to be used for interpreting actual medical images after training has been completed on how to use functions provided by the application program.

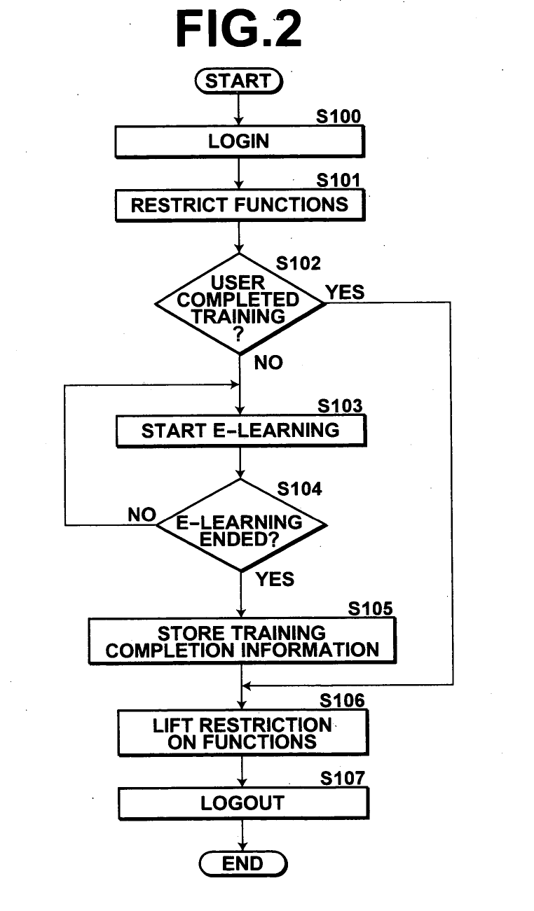

Therefore, in this embodiment, operation of the information processing apparatus 1 (hereinafter referred to as the CAD apparatus 1) is described for the case where training on CAD is carried out according to a flow chart shown in FIG. 2.

At the time of introduction of CAD, an engineer of a manufacturer providing the CAD apparatus 1 installs the CAD apparatus 1. Upon the installation, the engineer connects the CAD apparatus 1 having the CAD program installed therein to various kinds of modalities and an image storage apparatus 5 via a network 4 (see FIG. 1). After the installation has been completed, a service person of the manufacturer explains how to use the CAD apparatus.

Since the CAD program has an e-learning program as the training means 50 for providing the training function, users are briefed about how to use the functions provided by CAD, and then starts the CAD apparatus 1 for the training by the e-learning program.

When the CAD apparatus 1 is started, the login means 30 displays a login screen. Each of the users (hereinafter referred to as the user) logs onto the CAD apparatus 1 by inputting user information 32 such as his/her user name and ID in the login screen (S100). The CAD apparatus 1 then loads the application program 12 providing the functions of CAD stored in the program storage means 10, and executes the program on the execution environment 20. However, at the time of startup thereof, the restriction means restricts the functions of CAD (S101). Therefore, whether the login user has completed the training is judged based on the training completion information 60 stored in the training completion information storage means 58 (S102) In the case where the user has logged in for the first time, the user has not completed the training. Therefore, the restriction on the functions of CAD imposed by the restriction means 40 is maintained, and the user cannot carry out automatic abnormal shadow detection processing and the like.

In this case, the e-learning program of the training means 50 is started (S103). The e-learning program enables:

(1) display of description of the apparatus, instructions for use, methods for selecting a detection target and detection processing, methods of displaying detection results, and description of the detection processing; and

(2) display of actual cases on a screen and demonstration of cases together with display of CAD results.

The description of CAD represented by (1) above is displayed first on a display device of the CAD apparatus 1, and the description progresses while changing pages. Thereafter, the demonstration represented by (2) above is carried out for 10 cases or the like. In the case of mammography are displayed examples of calcified opacities and tumor shadows appearing in mammograms and examples of successful and unsuccessful detection of abnormal shadows.

If the user tries to use the functions of CAD such as automatic abnormal shadow detection before the user has completed all processes of the e-learning program, the restriction means 40 prevents the use.

When the training completion confirmation means 52 confirms that the user has completed all the processes of thee-learning (S104), the training completion information input means 56 inputs the training completion information 60 representing that the user has completed the training to the training completion information storage means 58, and the information is stored therein (S105). In order to enable recognition of the user having completed the training, the user information 32 of the login user is included in the training completion information 60. Alternatively, the user information 32 may be stored as the training completion information 60 in the training completion information storage means 58.

After the training completion information 60 has been stored, the restriction lifting means 42 lifts the restriction on provision of the functions of the application program 12 (S106), and let the user use the automatic abnormal shadow detection function.

The user then specifies a medical image P as a detection target stored in the image storage apparatus 5, and the CAD apparatus 1 reads the image P for carrying out automatic abnormal shadow detection processing by CAD. The user interprets the image P with reference to a displayed result of the detection, and generates a report or the like to be stored in the image storage apparatus 5. Thereafter, the user logs out for ending CAD (S107).

When the same user logs in to the CAD apparatus 1 (S100), the restriction means 40 firstly restricts the functions of CAD (S101) at the time of startup of the CAD program. However, since the login user is represented by the user information 32 of the training completion information 60 stored in the training completion information storage means 58, the CAD apparatus 1 judges that the user has completed the e-learning processes (S102). Therefore, the restriction lifting means 40 lifts the restriction on the functions of CAD (S106). In this manner, the user having completed the training can use the CAD functions without starting the e-learning program.

Meanwhile, in the case where another user not having completed the training logs in to the CAD apparatus 1 (S100), the restriction means firstly restricts the functions of CAD (S101) at the time of startup of the CAD program. Since the login user is not represented by the user information 32 included in the training completion information 60 stored in the training completion information storage means 58, the CAD apparatus 1 judges that the user has not completed the e-learning processes (S102), and maintains the restriction on the CAD functions imposed by the restriction means 40.

In the above description, the case of CAD has been described. However, the information processing apparatus 1 having the above configuration can be used for any application program that needs a trainer.

In the above description, the information processing apparatus 1 (the CAD apparatus 1) has the training function. In the case where the information processing apparatus 1 does not have the training function and the training has been completed by use of another apparatus or the like, the training completion information input means 56 may input the training completion information 60 to be stored in the training completion information storage means 58. Alternatively, the restriction lifting means 42 may lift the restriction so as to enable use of the functions of the application program 12 whenever the training completion information 60 is input.

More specifically, the training completion information 60 may be read and input from a memory storage medium or a magnetic card storing the training completion information 60. Alternatively, the training completion information 60 may be received via a network and input by the training completion information input means 56.

In the embodiment described above, completion of the training is managed for each of the users. However, in the case where the same user always use the same information processing apparatus, the functions of the application program by always be usable once the restriction has been lifted.

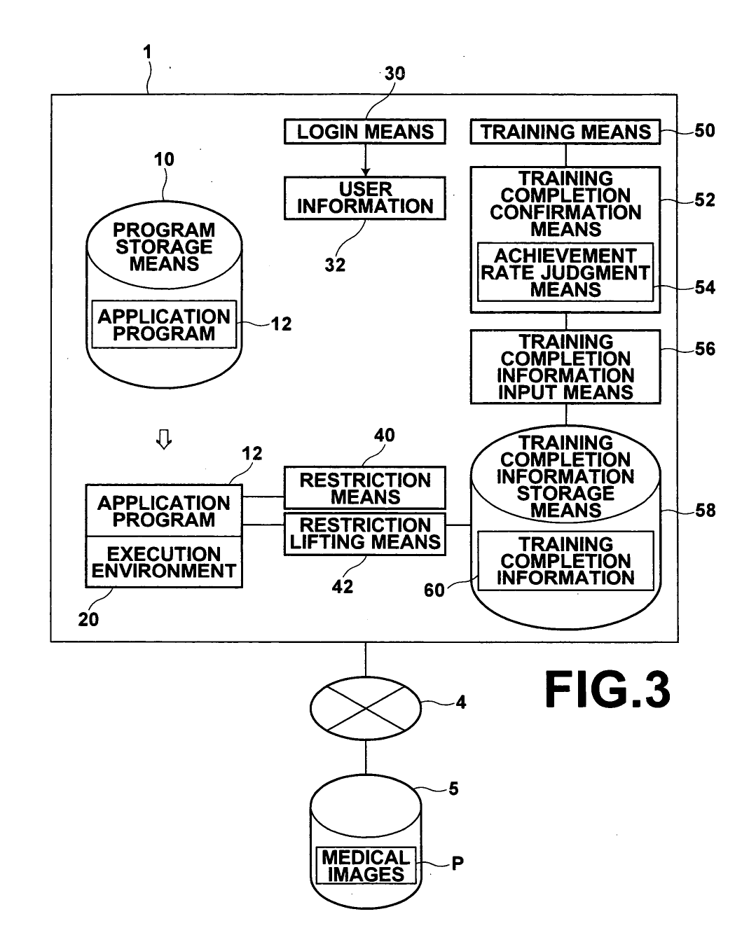

Furthermore, as shown in FIG. 3, the training completion confirmation means 52 may comprise achievement rate judgment means 54 for judging a rate of achievement in the training provided by the training means 50. In this case, completion of the training is judged based on the achievement rate.

More specifically, the automatic abnormal shadow detection processing is carried out on medical images representing various kinds of cases and whether respective results of the detection are right or wrong is input by each of the users. In this manner, the achievement rate judgment means 54 judges the achievement rate based on a percentage of correct answers input by the respective users.

By restricting the functions of the application program in the case where the users have not finished the training by the training function as has been described above, the cases are lessened where the users use the application program with misunderstanding of the functions.

In the above description, completion of the training is managed for each of the users within a single CAD system. In a second embodiment is described an information processing system connecting a plurality of client computers 2 that execute an application program and a management server computer 3 that manages users of the application program via a network 4 as shown in FIG. 3.

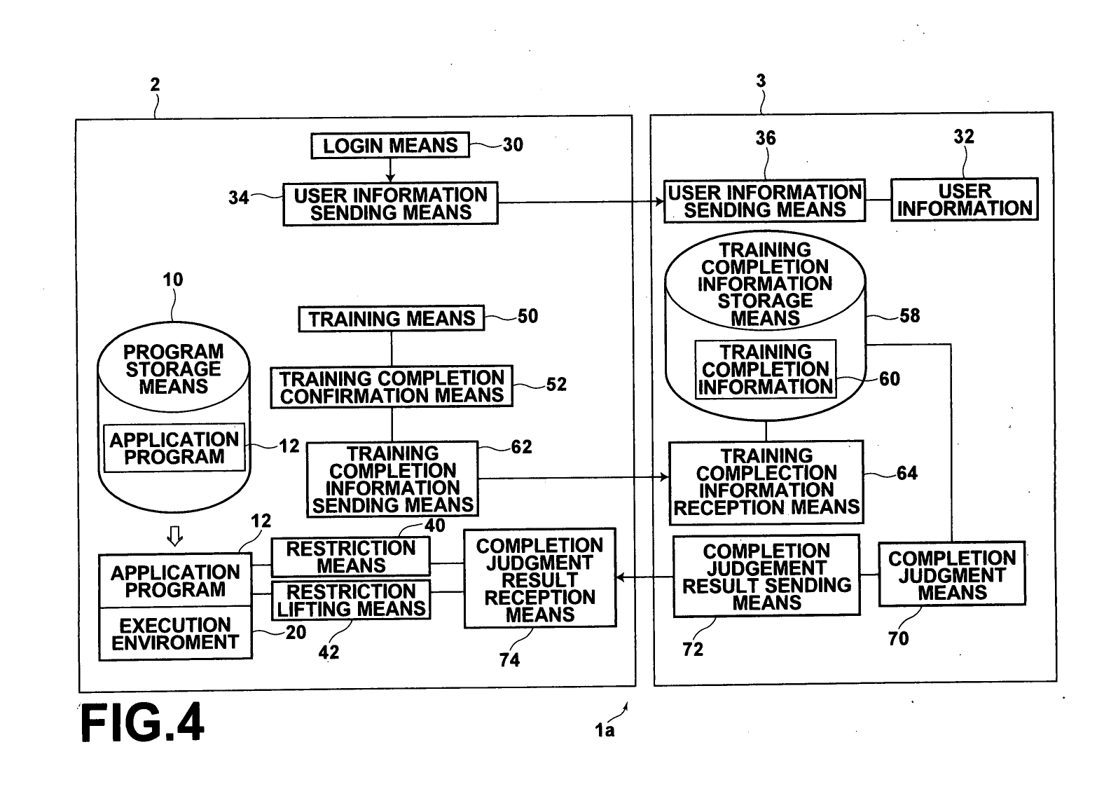

FIG. 4 shows the configuration of an information processing system 1a of the second embodiment. In this embodiment, the means having the same functions as the first embodiment have the same reference codes.

Each of the client computers 2 (hereinafter one of the client computers 2 is referred to as the client computer 2) in the information processing system 1a comprises login means 30 for letting a user log in, user information sending means 34 for sending user information 32 representing the login user to the management server computer 3, program storage means 10 for storing an application program 12, execution means (an execution environment) 20 for executing the application program 12, restriction means 40 for imposing a restriction on functions provided by the application program 12 when the application program 12 is executed in the execution environment, training means 50 for providing a training function carrying out training on how to use the functions of the application program 12, training completion confirmation means 52 for confirming completion of the training by the training means 50, training completion information sending means 62 for sending training completion information 60 including the user information 32 of a user having completed the training to management server computer 3, completion judgment result reception means 74 for receiving a result of judgment on whether the login user can use the application program 12 from the management server computer 3, and restriction lifting means 42 for lifting the restriction on provision of the functions of the application program 12 in the case where the login user has completed the training based on the result of the judgment.

The management server computer 3 comprises user information reception means 36 for receiving the user information 32 from the client computer 2, training completion information reception means 64 for receiving the training completion information 60 from the client computer 2, training completion information storage means 58 for storing the training completion information 60 of the user having completed the training on how to use the functions provided by the application program 12, completion judgment means 70 for carrying out the judgment as to whether the user logging in to the client computer 2 has finished the training based on the user information 32 received from the client computer 2 and the training completion information 60, and completion judgment result sending means 72 for sending the result of the judgment (hereinafter referred to as the completion judgment result) to the client computer 2.

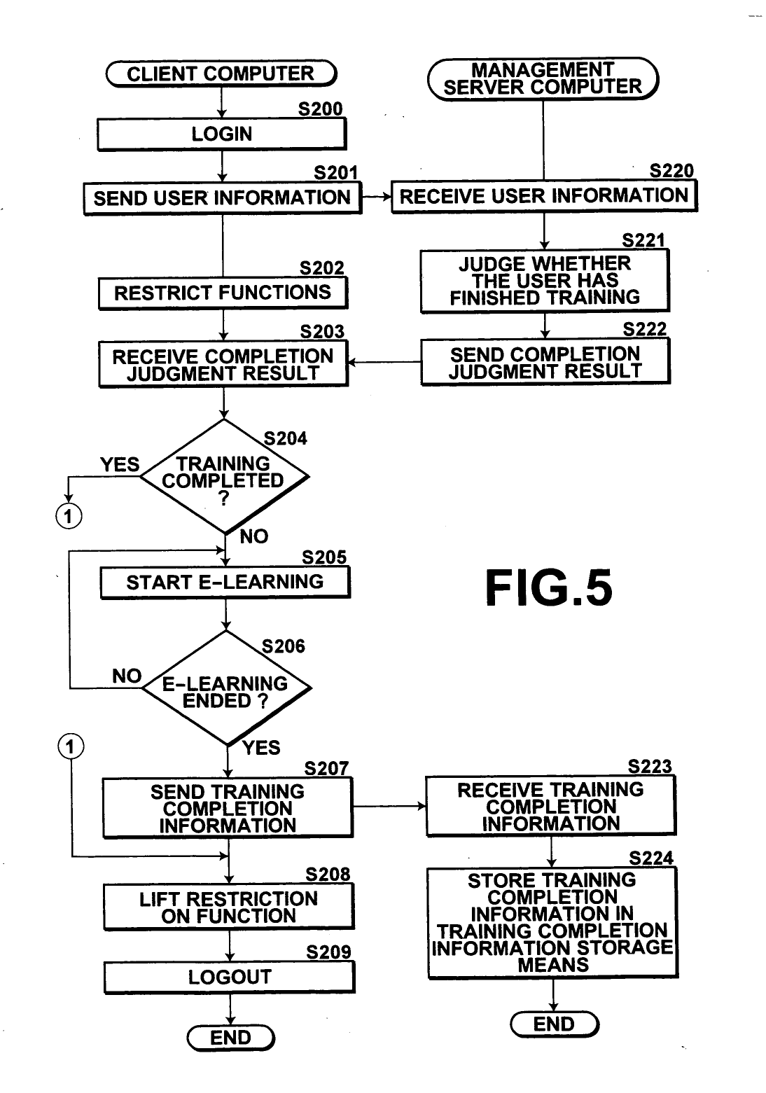

In this embodiment, operation of the information processing system 1a (hereinafter referred to as the CAD system 1a) is described for the case where training on CAD is carried out according to a flow chart shown in FIG. 5.

A user firstly starts the client computer 2 and inputs the user information 32 comprising his/her user name and ID in a login screen shown by the login means 30. The user information sending means 34 sends the user information 32 input by the user to the management server computer 3 (S201), and the management server computer 3 receives the user information 32 by use of the user information reception means 36 (S220). The completion judgment means 70 in the management server computer 3 judges whether the user currently logging in to the client computer 2 has finished the training based on the user information 32 received from the client computer 2 and the training completion information 60 stored in the training completion information storage means 58 (S221). In the case where the training completion information 60 is not found for the user logging in to the client computer 2 after a search of the training completion information 60 stored in the training completion information storage means 58, the completion judgment result sending means 72 sends the completion judgment result representing that the user has not completed the training to the client computer 2 (S222).

In the client computer 2, the application program 12 providing the functions of CAD and stored in the program storage means 10 is loaded and executed in the execution environment 20. At the time of startup of the program, the restriction means 40 restricts the functions of CAD (S202).

In the case where the completion judgment result reception means 74 in the client computer 2 receives the completion judgment result representing that the login user has not completed the training from the management server computer 3 (S203), the restriction on the functions of CAD is maintained based on the completion judgment result (S204: NO). The client computer 2 then starts an e-learning program of the training means 50 (S205). When the training completion confirmation means 52 confirms that the user has completed all processes of the e-learning program (S206), the training completion information sending means 62 sends the training completion information 60 representing that the login user has completed the training to the management server computer 3 (S207). In order to enable recognition of the login user having completed the training, the user information 32 of the login user is included in the training completion information 60. Alternatively, the user information 32 itself may be sent as the training completion information 60.

The training completion information reception means 64 in the management server computer 3 receives the training completion information 60, and the training completion information 60 is stored in the training completion information storage means 58 (S224). The client computer 2 lifts the restriction on the functions of CAD (S208) in response to completion of the training, and causes an automatic abnormal shadow detection function to be usable. Therefore, the user specifies an image as a target of detection stored in an image storage apparatus or the like (not shown), and carries out automatic abnormal shadow detection processing of CAD thereon. The user interprets the image with reference to a displayed result of the detection, and generates a report or the like to be stored in the image storage apparatus. Thereafter, the user logs out for ending the CAD system 1a (S209).

When the same user logs in to the CAD system 1a from any one of the client computers 2 (S200), the user information 32 is sent to the management server computer 3. The completion judgment means 70 in the management server computer 3 judges that the login user has completed the training (S221) based on the user information 32 in the training completion information 60 stored in the training completion information storage means 58 and based on the user information 32 of the login user, in the case where the training completion information 60 of the login user exists. The completion judgment result sending means 72 then sends the completion judgment result to the client computer 2 (S222). The completion judgment result reception means 74 in the client computer 2 receives the completion judgment result (S203), and finds that the user has completed the training based on the completion judgment result having been received (S204: YES). The restriction lifting means 42 then lifts the restriction on the functions of CAD (S208). In this manner, once the user has completed the training, the user can use the functions of CAD without starting the e-learning program, on any one the client computers 2.

In the case where another user not having finished the training logs in to any one of the client computers 2, the training completion information 60 stored in the training completion information storage means 58 does not include the user information 32 representing the login user. Therefore, the completion judgment means 70 judges that the user has not finished the e-learning processes, and the completion judgment result sending means 72 sends the completion judgment result to the client computer 2. The restriction on the functions of CAD is not lifted in the client computer 2, and the restriction means 40 maintains the restriction on provision of the CAD functions.

Alternatively, the training may be carried out on a computer other than the client computers 2. In this case, the training completion information storage means 58 of the management server computer 3 stores this fact.

The training completion information 60 may be stored manually in the training completion information storage means 58 of the management server computer 3.

As has been described above, in the information processing system of the present invention, the user once finished the training can use the application program not only on the client computer 2 on which the user has finished the training but also on any other one of the client computers 2.

What is claimed is:

1. An information processing apparatus comprising:
program storage means for storing an application program providing predetermined functions;
execution means for executing the application program;
restriction means for imposing a restriction on the functions provided by the application program when the application program is executed by the execution means;
training completion information input means for carrying out input of training completion information representing completion of training by a training function on how to use the functions provided by the application program; and
restriction lifting means for lifting the restriction imposed by the restriction means on provision of the functions of the application program, based on the input of the training completion information.

2. An information processing apparatus comprising:
program storage means for storing an application program providing predetermined functions;
execution means for executing the application program;
restriction means for imposing a restriction on the functions provided by the application program when the application program is executed by the execution means;
training means for providing a training function carrying out training on how to use the functions of the application program;
training completion confirmation means for confirming completion of the training by the training means;
training completion information storage means for storing training completion information representing the completion of the training after the training completion confirmation means has confirmed the completion of the training; and
restriction lifting means for lifting the restriction imposed by the restriction means on provision of the functions of the application program, based on the training completion information.

3. The information processing apparatus according to claim 1 further comprising login means for letting a user log in thereto, wherein
the training completion information includes user information on a user having completed the training and
the restriction lifting means lifts the restriction in the case where the user currently logging on by use of the login means agrees with the user information included in the training completion information.

4. The information processing apparatus according to claim 2 further comprising login means for letting a user log in thereto, wherein
the training completion information includes user information on a user having completed the training and
the restriction lifting means lifts the restriction in the case where the user currently logging on by use of the login means agrees with the user information included in the training completion information.

5. The information processing apparatus according to claim 2 wherein the training completion confirmation means comprises achievement rate judgment means for judging a rate of achievement in the training by the training means and confirms the completion of the training based on the rate of achievement judged by the achievement rate judgment means.

6. The information processing apparatus according to claim 4 wherein the training completion confirmation means comprises achievement rate judgment means for judging a rate of achievement in the training by the training means and confirms the completion of the training based on the rate of achievement judged by the achievement rate judgment means.

7. The information processing apparatus according to claim 1 wherein the predetermined functions are for image processing.

8. The information processing apparatus according to claim 2 wherein the predetermined functions are for image processing.

9. The information processing apparatus according to claim 3 wherein the predetermined functions are for image processing.

10. The information processing apparatus according to claim 4 wherein the predetermined functions are for image processing.

11. The information processing apparatus according to claim 5 wherein the predetermined functions are for image processing.

12. The information processing apparatus according to claim 6 wherein the predetermined functions are for image processing.

13. An information processing system comprising:
a client computer executing an application program providing predetermined functions and a management server computer managing users using the application program, the client computer and the management server computer being connected to each other via a network,
the client computer comprising:
login means for letting a user log in thereto;
user information sending means for sending, to the management server computer, user information representing the user having logged on;
program storage means for storing the application program;
execution means for executing the application program; and
restriction means for imposing a restriction on the functions provided by the application program when the application program is executed by the execution means,
the management server computer comprising:
user information reception means for receiving the user information from the client computer;
training completion information storage means for storing training completion information including user information of a user having completed training on how to use the functions provided by the application program;
completion judgment means for carrying out judgment as to whether the user logging onto the client computer is the user having completed the training, based on the training completion information and the user information received from the client computer; and
completion judgment result sending means for sending a result of the judgment by the completion judgment means to the client computer, and
the client computer further comprising:
completion judgment result reception means for receiving the result of the judgment from the management server computer; and
restriction lifting means for lifting the restriction imposed by the restriction means on provision of the functions of the application program in the case where the user logging onto the client computer has been confirmed to have completed the training according to the result of the judgment.

14. The information processing system according to claim 13, the client computer further comprising:
training means for providing a training function carrying out training on how to use the functions provided by the application program to the user having logged on,;
training completion confirmation means for confirming that the user has completed the training; and
training completion information sending means for sending training completion information including the user information of the user having completed the training to the management server computer, and
the management server computer further comprising:
training completion information reception means for receiving the training completion information from the client computer.

15. The information processing system according to claim 13 wherein the predetermined functions are for image processing.

16. The information processing system according to claim 14 wherein the predetermined functions are for image processing.

17. A program causing a computer to function as:
restriction means for imposing a restriction on predetermined functions provided by an application program when the application program providing the functions is executed by execution means of the computer;
training completion information input means for carrying out input of training completion information representing completion of training on how to use the functions provided by the application program; and
restriction lifting means for lifting the restriction imposed by the restriction means on provision -of the functions of the application program, based on the input of the training completion information.
